(19) United States
(12) Patent Application Publication
(10) Pub. No.: US 2025/0125670 A1
(43) Pub. Date: Apr. 17, 2025

(54) ELECTRIC MOTOR AND HANDWHEEL ACTUATOR ASSEMBLY INCORPORATING A MOTOR

(71) Applicant: ZF Automotive UK Limited, Solihull (GB)

(72) Inventor: Christos Prevezianos, Birmingham (GB)

(21) Appl. No.: 18/911,763

(22) Filed: Oct. 10, 2024

(30) Foreign Application Priority Data
Oct. 12, 2023 (GR) 20230100839

(51) Int. Cl. H02K 1/14; B62D 5/04; H02K 15/121; H02K 15/40

(52) U.S. Cl. CPC H02K 1/146; B62D 5/046; H02K 15/121; H02K 15/40; H02K 2201/03

(57) ABSTRACT

An electric motor includes a stator and a rotor. The stator carries a plurality of phase windings. The rotor carries a plurality of magnet poles and is connected to a shaft. The stator includes an outer annular yoke and a plurality of discrete teeth that are separate from the annular yoke. Each tooth has a stem and a tooth tip that is located at the end of the stem closest to the roto. An inner annular sleeve is located in what is otherwise an airgap between the inwardly facing tips of the stator teeth and the rotor. The inner sleeve includes location features that positively locate and support the teeth by the tips.

### RELATED APPLICATIONS

This application claims priority from GR patent application No. 20230100839, filed 12 Oct. 2023, the entirety of which is hereby incorporated herein by reference.

### TECHNICAL FIELD

This invention relates to electric motors in particular but not exclusively those suitable for use in a handwheel actuator assembly for use in a steer by wire system of a vehicle.

### BACKGROUND

Electric motors are widely used and are increasingly common in automotive applications. For example, it is known to provide an electrically power assisted steering system in which an electric motor apparatus applies an assistance torque to a part of a steering system to make it easier for the driver to turn the wheels of the vehicle. The magnitude of the assistance torque is determined according to a control algorithm which receives as an input one or more parameters such as the torque applied to the steering column by the driver turning the wheel, the vehicle speed and so on.

Another example of use of electric motors in automotive applications is in steer-by-wire systems. During normal use, these systems have no direct mechanical link from the hand wheel that the driver moves and the steered wheels. These systems rely on sensors to relay user input data at a steering wheel to control units which integrate user input data with other information such as vehicle speed and yaw rate, to deliver control signals to a primary motor that physically actuates a steering rack of the vehicle. The control units also act to filter out unwanted feedback from the front wheels and provide a response signal to a secondary actuation system comprising one or more electric motors coupled to the steering wheel. The secondary motor, or plurality thereof, provides the driver with the appropriate resistance and feedback in response to specific user inputs at the steering wheel to mimic the feel of a conventional steering system. This secondary motor is connected to a shaft that supports the handwheel through a gearset, and those three parts collectively form a Handwheel Actuator Assembly.

The motors in a steer by wire system are typically constructed with a stator that comprises laminations stacked together in the axial direction. These laminations typically comprise sheets of electrical steel. This is both a cost-effective way to manufacture the motors, but also by applying an electrically insulating coating between each lamination in the stack currents are prevented from flowing axially through the stator steel. This reduces energy losses within the motor that would otherwise result from current flowing axially in the stator steel. Such a prior art motor construction exhibits a low level of drag torque from the elimination, or severe restriction, of the current that flows axially. Other components may be fixed to the stator steel, such as phase windings and end caps and guide wires.

The term drag torque as used in this description means a torque that is generated by the motor when it is rotating that opposes any torque that is applied to drive the motor. The rotor of a motor which has all of the stator winding phases open-circuited with virtually zero drag torque can be spun with only a small amount of external torque applied, one with a very high drag torque will require an equally high or higher external torque to make the rotor rotate.

In a steer-by-wire system, a malfunction or failure of a portion of the assembly may impair the ability to steer the vehicle. As a result, it is desirable to provide the assembly with structure for providing at least temporary fail-safe operation. US 2006/0042858 A1 discloses steering apparatus including a steering assembly that includes a handwheel actuator. The handwheel actuator includes a steering column for supporting a steering wheel, a gear mechanism and two motors, each for providing a torque to the steering column. Single motor handwheel actuator assemblies are also known.

When the steer by wire system is powered up and functioning correctly, the HWA imposes torque on the shaft carrying the handwheel that in most use cases resists the driver turning the steering wheel shaft. For much of the operation of the system, the motor or motors within the handwheel actuator operate as a controlled resistance to the driver. This can be used to give the driver a feel for what is happening at the interface between the road wheels and the road surface that has otherwise been lost with the removal of the mechanical link from the handwheel to the road wheels.

It is undesirable for the hand wheel to be able to rotate freely and a small amount of resistance to movement, which the driver can always overcome is always desirable. Preferably, this resistance to motion is either constant or proportional to the handwheel speed to enable a good steer-feel. In the prior art it is known to provide resistance to movement by absorbing energy within the motor drive electronics using a principle known as braking torque. For example, see the disclosure of Hendershot & Miller ISBN 978-0-9840687-0-8, page 507 where they talk about braking torque in a line start PM motor arising from current flowing through an external short circuit A braking torque is created when there is at least one closed circuit through the motor phases in which current generated as the motor rotates will flow. This requires active control of the motor drive circuit to operate-typically close-appropriate phase switches and force the closed circuit in the motor.

The applicants have appreciated that it is desirable that this resistance should be present even if the electrical power is removed from the system. Where the resistance is achieved by application of appropriate currents to the motor, this resistance will be removed in the event of a fault where currents cannot be supplied or generated within the motor. The applicants have also appreciated that it is desirable to have minimum electrical connections to the motor and to avoid the use of auxiliary windings and connected controllers to create the resistance to motion in the event of a fault within the system.

### SUMMARY

One object of the present invention is to provide a motor and a handwheel actuator assembly incorporating such a motor that provides a desirable level of resistance to rotation when the motor is not powered.

For most applications it is beneficial for the motor in a handwheel actuator assembly to be as small as possible, in particular the overall length and diameter of the motor, due to packaging constraints, Reducing the size does present challenges in assembly, particularly the application of the coils of electrical wire to the stator teeth. In many systems it is not desirable for the motor to resist rotation when it is unpowered but it is frequently desirable to make a motor as compact as possible. It is a further object in at least one aspect of the invention to provide a motor which is simpler to assemble especially where the motor has to be small to fit within a restricted space as is often the case in application such as automotive systems.

According to a first aspect the invention provides an electric motor comprising a stator and a rotor, the stator carrying a plurality of phase windings and the rotor carrying a plurality of magnet poles and being connected to a shaft; and
in which the stator comprises an outer annular yoke, a plurality of discrete teeth that are separate from the annular yoke, each tooth comprising a stem and a tooth tip that is located at the end of the stem closest to the rotor,
and an inner annular sleeve that is located in what is otherwise an airgap between the inwardly facing tips of the stator teeth and the rotor, and in which the inner sleeve includes location features that positively locate and support the teeth by the tips.

The inner sleeve may comprise an electrically conductive material, by which we mean one with a low electrical resistance such as a metal or metal alloy or metal matrix composite. When the inner annular yoke comprises an electrically conductive material this will provide a flux path that extends axially along the motor bore so that rotation of the rotor generates eddy currents within the sleeve that resist rotor rotation. The sleeve may also optionally be magnetically permeable such that it generates hysteresis loss which can complement the eddy current loss. The eddy currents generate a resisting torque that is proportional to speed while the hysteresis would generate a constant resisting torque. Complementary hysteresis loss would then be beneficial to increase resistance at low speeds.

In an alternative, the inner sleeve may comprise insulating material if the objective is to minimize motor rotational losses rather than increase them.

The material or part thereof may also be magnetically permeable if this provides an advantage to the motor desired application. A carefully chosen shape, permeability and saturation flux density can help achieve the optimal flux density to reduce the torque ripple or cogging torque of the motor without significantly affecting torque capability. In addition, if the material is permeable, it can reduce the variation of airgap permeance between the main tooth-tips and the material between them situated in the slot opening, which can reduce rotor losses in high speed motors. The material can be chosen to have a permeability and saturation flux density that best serves the application. The relative permeability could be as low as 18 for some soft magnetic composites or as high as 4000 for electrical steel. The saturation flux density can vary from 0.9 T to more than 1.5 T.

The motor(s) of the invention where the sleeve is electrically conductive generates a desirable level of eddy current and hysteresis loss when the rotor is being turned without the motor being under electrical power and therefore offers a relatively high resistance to rotation, achieved from a sleeve of electrically conductive material in the airgap between the stator and the rotor.

The invention incorporates into the motor a conductive part fitted in the inside of the stator bore within the magnetic airgap of the machine that supports individual teeth. This bring benefits in terms of assembly allowing easier access to the teeth from the outside of the motor for instance to install windings after which the outer yoke can be fitted. This a benefit that can be achieved in addition to the optional provision of a conductive sleeve for applications that require a high motor braking torque.

The inner annular sleeve may comprise a solid walled tubular sleeve that is fitted in the airgap between the rotor and the stator.

The rotor may be located concentrically within the stator, each sharing a common axis.

The outer yoke may include a set of locating features on an inner surface that engage with the ends of the teeth furthest from the rotor.

The outer surface of the inner sleeve may include a plurality of ribs, each rib extending radially outward into a space between adjacent tips of the stator teeth to locate the individual teeth. The side walls of each rib may include an undercut which receives part of a tooth head so that the teeth cannot move radially, tangentially or circumferentially away from the inner sleeve. Installation can be performed by sliding the teeth axially into the space between adjacent ribs either linearly or using a twisting motion depending on the shape of the teeth and the location features.

In an alternative, the inner sleeve may include a set of grooves in the outer circumferential surface, each one locating the tip of a tooth. Again, the side walls of the grooves may be undercut to positively restrain the tooth. The side walls of each groove may include an undercut which receives part of a tooth head so that the teeth cannot move radially, tangentially or circumferentially away from the inner sleeve. Installation can be performed by sliding the teeth axially into the groove either linearly or using a twisting motion depending on the shape of the teeth and the location features.

The inner sleeve may comprise an overmolding in which at least part of the tip of each tooth is embedded within the overmolded inner sleeve, the void that the teeth occupy defining the location feature for the tooth.

To form a motor with an overmolded inner sleeve the tooth segments may be located with the aid of tooling in their intended locations within a mold suitable for injection molding. This would be particularly useful if the sleeve component is made out of a plastic or any material that can be injection molded. The end result is a solid part incorporating the sleeve with all the stator teeth firmly embedded within the sleeve material that would require no further assembly.

The motor may include a set of coil windings that surround the teeth and are connected together to form individual phases. There may for example be three phases each having coils wound around two or more of the teeth. The windings can be arranged in a variety of different ways depending on the performance characteristics, number of slots and poles required from the motor and the motor drive and control strategy that may be used with the motor.

Because the teeth are separate from the outer yoke prior to assembly these coils can be wound separately around the teeth prior to the teeth being inserted into the recesses of the sleeve, and then the whole star-shaped assembly can be inserted in a round yoke that will serve as the back-iron of the machine. The coils could also be wound separately around appropriate fixtures or tooling and then subsequently dropped into place around the intended tooth or teeth.

Each tooth may comprise a generally rectangular block with an enlarged tip extending along one edge that engage the inner sleeve. This block may comprise a stack of laminated electrically conductive plates.

In concentrated-wound machines, preferably every tooth is provided with a loop of conductive wire that is wrapped around the stem of the tooth between the tooth head and the end that contacts the outer annular yoke. In distributed-wound machines, the loop can be wound around different teeth and different sides thereof after the teeth have been inserted or embedded in the sleeve grooves. The coils can also be The slots may contain one or more coil sides often referred to as “winding layers”.

The inner diameter/bore of the stator sleeve need not be entirely round, but may feature protrusions, recesses, flat parts, radii, chamfers or any other distinct geometry that may aid in keeping the flux density as sinusoidal as possible in order to reduce the ripple component of the damping torque or the torque ripple of the machine during regular operation.

The height of the sleeve measure in the axial direction of the motor may be substantially the same as the height of the stator. As such it may extend from one end of the stator to the other. It may be shorter or longer than this relative to the stator.

The sleeve may include a plurality of cuts out that extend from the inner circumferential wall of the sleeve to the outer circumferential wall whereby strips of material are defined between the cut outs that provide the axially conductive paths. These cut outs may permit air to flow from one side of the sleeve to the other which may be helpful for cooling of the motor.

The stator sleeve may be located within an airgap that has a length, measured radially from the centre of rotation, that is suitable to achieve the desired electromagnetic properties of the electric motor. It can be smaller to increase produced torque per unit of volume or larger to reduce eddy current losses in the rotor in the case of high speed machines such as fuel cell compressor machines.

The sleeve may have a length, again measured radially, that would best achieve the required performance aspect, such as mechanical strength, maximization of electrical losses if the objective is to increase torque resisting motion or minimization of aerodynamic losses and rotor electromagnetic losses if the objective is to minimize torque resisting motion.

The sleeve may comprise a metal or metal alloy and may be homogeneous. For example, it may be cast, or pressed or rolled from a uniform stock material.

The sleeve may be made of plastic, injection molded onto the rectangular teeth or made separately and insert the teeth in its grooves as a next step.

The sleeve may comprise a copper sleeve or an aluminium sleeve, or any other material that provides the properties required by the application or to facilitate manufacturing or to reduce costs.

When the objective is to maximize braking torque, the highest possible conductivity is beneficial, making copper the most useful option per unit of mass and cost, but aluminium alloys can be useful to reduce cost or to prevent galvanic corrosion.

When the objective is to minimize losses and braking torque, such as the case of high speed compressors, the material can be any plastic that provides the requisite mechanical strength, facilitates manufacturing and is cost-effective. The material may have a low magnetic loss and moderate to low permeability which can potentially help improve some aspects of magnetic performance.

The lower the resistance the stator sleeve has the higher the losses and therefore the higher the resistance torque felt when the shaft is rotated. In an embodiment with the objective of high braking torque, the sleeve may have a resistivity of generally less than 5e-8 Ωm. The sleeve may have a resistivity of about 3.8e-8 Ωm when made of aluminium alloys or when made of copper has a resistivity of 1.724e-8 Ωm. Any alloyed material that provides the requisite galvanic or mechanical properties that could prevent corrosion and enhance manufacturability may have resistivities that deviate from these values. The sleeve radial length or thickness can then be increased or reduced accordingly to achieve the desired amount of braking torque.

The motor stator may be configured such that the motor stator assembly excluding copper windings has an effective loss per mass of at least 50 Watts per kg of EM-active motor material at a rotational speed of 1000 rpm.

The sleeve may provide the primary source of drag of the motor, although it may be combined with other features that provide a controlled amount of drag.

The motor may be configured to provide at least 60 percent of the resistance to rotation of the rotor at least one speed in the range, or at least 70 percent, or 80 percent, or substantially all of the drag torque over a range of non-zero rotational speeds. The motor may provide all or substantially all of the resistance to rotation of the output shaft, by which we mean at least an order of magnitude larger than any resistance provided by mechanical friction present in the motor. The resistance to rotation would typically be amplified by the gearset.

The motor may be configured to provide at least 2 Nm of drag torque over a substantial range of non-zero rotational speeds of the output shaft taking account of gearing between the motor and the output shaft where provided.

The drag torque of the motor may provide at least 60 percent, or at least 70 percent or higher of the resistance to rotation of the shaft at 180 degrees/second speed of rotation of the shaft. It may provide all or substantially all of the resistance to rotation of the shaft, by which we mean at least an order of magnitude larger than any resistance provided by mechanical friction present.

In other arrangements where a low drag torque is desirable the inner sleeve may be an electrically insulating material such as an epoxy. This allows the benefits of easy assembly to be obtained in a motor that may have a low drag.

In accordance with a second aspect the invention provides a method of assembling a motor having the features of the first aspect comprising:
providing an inner sleeve and a set of individual stator teeth,
Forming a sub assembly by fixing the individual teeth to the inner sleeve using the locating features of the inner sleeve to form a star shaped subassembly and winding electrical wire around the teeth to form the coils; and
Inserting the sub assembly axially into the outer annular yoke.

The method of this aspect can potentially allow for higher slot fill factor and better positional control of the teeth compared with a prior art arrangement in which the teeth are secured only at the outer ends by an integral outer yoke leading to smaller asymmetries, which in turn can reduce pole-order cogging leading to a better steer-feel.

In addition, allowing for higher fill factor means more room in the slot is available which can be used to fit highly conductive loops to complement the sleeves eddy current losses.

The sub assembly may be a press fit into the outer annular yoke.

The teeth may each be a press fit into the inner sleeve.

The method may comprise applying adhesive to one or more surfaces during assembly such that when the assembly is completed the cured adhesive secures the teeth to the outer yoke and optionally to the inner sleeve.

The step of fixing the teeth to the inner sleeve may comprise engaging the tip of the teeth with a groove in the inner sleeve or between adjacent ribs on the outer surface of the inner sleeve

In accordance with a second aspect the invention provides a method of assembling a motor having the features of the first aspect comprising:
Placing a set of individual stator teeth into a mold or other retaining device,
Forming a sub assembly by overmolding an inner sleeve that encapsulates at least a part of a tip of each tooth to form a star shaped subassembly and winding electrical wire around the teeth to form the coils; and
Inserting the sub assembly axially into the outer annular yoke.

In accordance with a fourth aspect of the present invention, there is a handwheel actuator assembly of a steer by wire vehicle comprising:
a housing;
a shaft rotatably mounted with respect to the housing;
one or more motors each having a stator and a rotor, the stator carrying a plurality of phase windings and the rotor carrying a plurality of magnet poles and being connected to the shaft;
a control circuit adapted to control the current flowing into or out of the or each motor to cause a net torque to be applied to the shaft during normal operation, and
in which at least one of the motors comprises a motor in accordance with the first aspect of the invention and in which the inner sleeve comprises an electrically conductive and optionally magnetically permeable material.

The mechanical assembly may include a gearbox comprising a first gear fixed relative to the shaft and a second gear fixed relative to the output of the motor, rotation of the first gear causing a rotation of the second gear.

The two gears may be directly meshed or may be connected to each other through a belt. Where the mechanism is part of a handwheel actuator assembly, the handwheel actuator may comprise a second gear connected to and configured to rotate with the shaft; and a second motor having an output driving a respective second output gear, the second output gear being engaged with the first gear and hence the shaft.

This second motor may also generate a significant drag torque such that the sum of the drag torque from both motors provides a substantially resistance to the turning of the handwheel when the motor is unpowered.

Alternatively, the second motor may have a more conventional construction using electrical steel as the rotor so that it does not play a significant role in the overall resistance to rotation when unpowered. The first motor may therefore provide considerably more drag torque compared to the second for instance at least double the drag torque.

The motor may comprise a brushless permanent magnet type motor comprising a rotor and a stator having many windings surrounding regularly circumferentially spaced teeth.

The shaft may be connectable to a handwheel directly through a splined connector on an end of the shaft fitting in an internally splined connector of the handwheel. The shaft will therefore rotate at the same speed as the handwheel. The motors if directly connected to the shaft will also rotate at the same speed. If the motors are connected to the shaft through a gearbox, they will rotate at a different speed to the handwheel.

Alternatively, the shaft may be connected to the handwheel through a gearbox. In this case the rotational speed of the shaft may differ from the rotation speed of the handwheel.

The motor may form a part of a handwheel actuator assembly of a steer by wire vehicle in which the motor rotor is connected to a shaft that in turn is connected to a handwheel of the vehicle and the handwheel actuator assembly is configured such that in the event that the control circuit is powered down or disconnected and the handwheel is rotated at 180 degrees per second the combination of motors overall provides a drag torque of at least 50 percent of the resistance to rotation of the shaft and a torque at the handwheel of at least 3 Nm.

The handwheel actuator assembly may comprise two of the motors of the first aspect of the invention, the rotor of each motor being connected to the shaft that in turn is connected to the handwheel.

By providing one or more motors where at least one provides a significant and useful level of drag torque, the driver must apply at least 3 Nm at a handwheel speed of 180 degree/second to maintain a constant speed of rotation of 180 degree/second of the handwheel as that resistance must be overcome before any extra torque is used to accelerate the handwheel. This level of resistance is generally considered acceptable in an automotive handwheel actuator application. If it is too low the steering feels too light and may be too easy to turn at high speeds comprising stability, but if too high it may make the steering so heavy the driver may struggle to turn the wheel and manoeuvre the vehicle. When in electrical contact with the stator laminations, the function of the conducting metal coating is to improve conductivity between adjacent laminations such that it approximates the electrical conductivity of a solid magnetic component, such as a stator stack, thereby promoting larger eddy-currents than would normally be the case with insulated laminations in a stack.

The invention provides a damping of an otherwise uncontrolled rotation without electronics, additional mechanical components or complexity that prevents the steering wheel rotating freely when the power is removed, motor disconnected, or under certain fault conditions that render the control unit electrically inoperative. Removing the need to lose energy in the drive circuit, as is known from the prior art, protects the circuit from damage due to heat build-up and moves the heat loss into the motor where it can better be managed.

### BRIEF DESCRIPTION OF THE DRAWINGS

There will now be described by way of example only one embodiment of the present invention with reference to and as illustrated in the accompanying drawings of which:

FIG. 1 shows the key mechanical components of an embodiment of a handwheel actuator assembly according to an aspect of the invention that includes a pair of motors that may each fall within a further aspect of the invention;

FIG. 2 shows another embodiment of a handwheel actuator assembly according to an aspect of the invention;

FIG. 3 shows a general arrangement of an electronic control unit which controls the two motors of a dual motor drive assembly according to a first aspect of the invention;

FIG. 4 shows a layout of a Steer-by-Wire system including a dual motor drive assembly according to a first aspect of the invention;

FIG. 5 shows the first steps of assembly of an embodiment of a motor in accordance with an aspect of the invention to form a sub-assembly;

FIG. 6 shows the remaining steps of assembly of the motor of FIG. 5;

FIG. 7 shows an alternative motor with an overmolded inner sleeve which represents embodiment of a motor according to the present invention; and

FIG. 8 shows the eddy current density of a simple sleeve of FIG. 5 when the rotor is turned whilst the motor is isolated from a supply of electrical power.

### DESCRIPTION

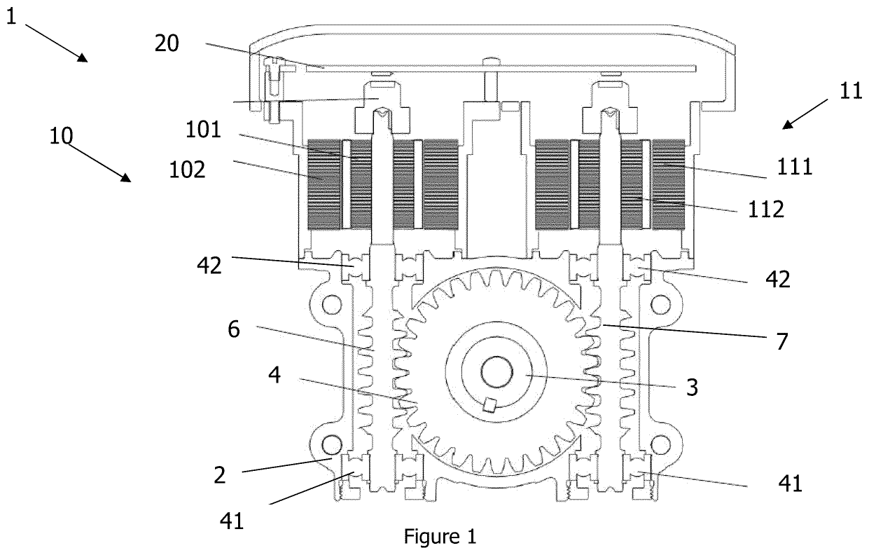

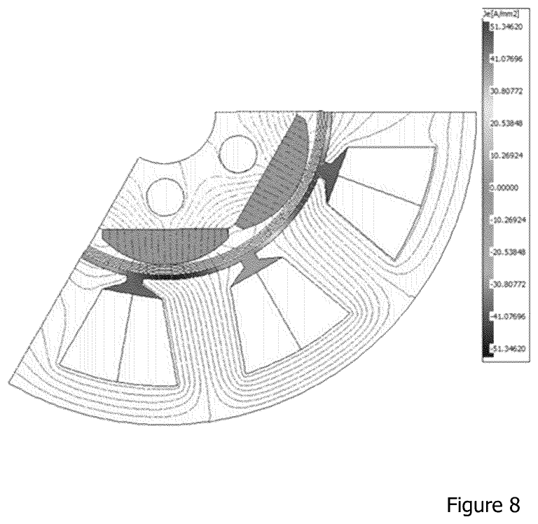

FIG. 1 shows a handwheel actuator (HWA) assembly of a vehicle, according to a first aspect of the invention. This example is a dual motor assembly which has two motors, each connected to a common shaft through a respective gearbox. The invention can be implemented with a single motor and also without the presence of a gearbox by direct connection of the motor rotor to the shaft. The motors have special properties and embody the first aspect of this invention and examples of the motor construction are presented in FIGS. 8 to 11. By describing the motors in relation to one potential use in a handwheel actuator assembly the benefits of these motors over conventional motors in such applications can be readily understood.

The assembly 1 includes a first motor 10 with rotor 101 and stator 102 and a second motor 11 with rotor 111 and stator 112, the first motor 10 being connected to a first worm gear 6 and the second motor 11 being connected to a second worm gear 7. Each worm gear 6, 7 comprises a threaded shaft arranged to engage with a gear wheel 4 connected to a steering column shaft 3 such that torque may be transferred from the worm gears 6, 7 to the gear wheel 4 connected to the steering column shaft 3. The gear wheel 4 is operatively connected to a driver's handwheel (not shown) via the steering column shaft 3. In this example, each of the two motors 10, 11 are brushless permanent magnet type motors and each comprise a rotor 101, 111 and a stator 102, 112 having many windings surrounding regularly circumferentially spaced teeth. The arrangement of the two motors 10, 11, the shaft 3, the worm gears 6, 7 and the wheel gear 4 together form a dual motor electrical assembly.

Each of the two motors 10, 11 are controlled by an electronic control unit (ECU) 20. The ECU 20 controls the level of current applied to the windings and hence the level of torque that is produced by each motor 10, 11.

In this example, the two motors 10, 11 are of a similar design and produce a similar level of maximum torque. However, it is within the scope of this disclosure to have an asymmetric design in which one motor 10, 11 produces a higher level of torque than the other 10, 11.

One of the functions of a handwheel actuator (HWA) assembly is to provide a feedback force to the driver to give an appropriate steering feel. This may be achieved by controlling the torque of the motors 10, 11 in accordance with signals from the handwheel actuator (such as column angle) and from other systems in the vehicle (such as vehicle speed, rack angle, lateral acceleration and yaw rate).

The use of two motors 10, 11 is beneficial in eliminating rattle. If a single electric motor were instead used in a torque feedback unit, the motor may be held in locked contact with the gearing by means of a spring. However, in certain driving conditions the action of a spring is not sufficiently firm, which allows the gears to “rattle” during sinusoidal motions or sharp position changes of the steering column.

Use of two motors 10, 11 which can be actively controlled (as in the present embodiment) ameliorates the problems associated with use of a single motor. In this arrangement, both motors 10, 11 are controlled by the ECU 20 to provide torque feedback to the steering column and to ensure that the worm shafts 6, 7 of both motors 10, 11 are continuously in contact with the gear wheel 4, in order to minimise rattle. The use of two motors 10, 11 in this way also allows active management of the friction and thereby the feedback force to the driver.

As shown in FIG. 1, the motors 10, 11 are received in and secured to a transversely extending two-part extension of a housing 2. The worm shaft 6, 7 of each motor is supported relative to the housing by two sets of bearings. A first set of bearings 41 supports a first end of each worm shaft 6, 7 distal their respective motor 10, 11 while a second set of bearings 42 supports a second end of each worm shaft 6, 7 proximal their respective motor 10, 11.

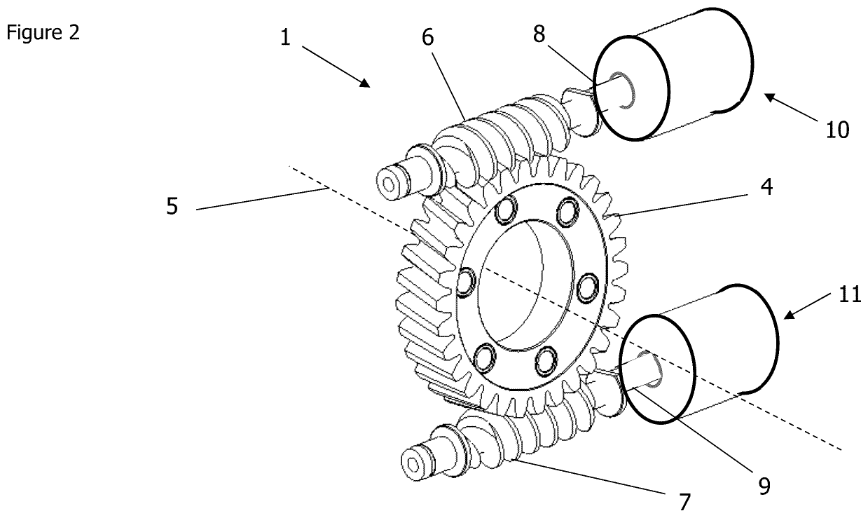

FIG. 2 shows an axis of rotation of the shaft 3 marked using a dashed line 5, extending perpendicularly through the gear wheel 4. The periphery of the gear wheel 4 is formed as a worm gear which meshes with each of two identical worm screws 6, 7 located on opposite sides of the longitudinal axis 5 of the shaft 3. Each worm screw 6, 7 is connected to the output shaft 8, 9 of a respective electric motor 10, 11.

The axes of the output shafts 8, 9 of the two motors 10, 11 are arranged perpendicularly to the rotational axis of the shaft 3 and the axes of the two motors may also be inclined with respect to each other, to reduce the overall size of the assembly.

The motors 10, 11 are controlled by the electronic control unit (ECU) 20 such that at low levels of input torque applied to the shaft 3 by the handwheel, the motors 10, 11 act in opposite directions on the gear wheel 4 to eliminate backlash. At higher levels of input torque applied to the shaft 3 by the handwheel, the motors 10, 11 act in the same direction on the gear wheel 4 to assist in rotation of the shaft 3. Here, a motor 10, 11 acting in ‘a direction’ is used indicate the direction of torque applied by a motor 10, 11 to the gear wheel 4.

The use of two separate motors 10, 11 which can be controlled in a first operational mode to apply torque in opposite directions to the gear wheel 4 eliminates the need to control backlash with precision components. In addition, the use of two separate motors 10, 11 which can be controlled in a second operational mode to apply torque in the same direction to the gear wheel 4 allows the motors 10, 11 and gear components 4, 6, 7 to be specified at half the rating of the required total system torque, thereby reducing the size and cost of the drive assembly 1.

In the embodiment shown in FIGS. 1 and 2, the worm shafts 6, 7 engage diametrically opposed portions of a gear wheel 4. The threads of the worm shafts 6, 7 each have the same sense, i.e., they are both left-handed screw threads. The motors 10, 11 are configured such that they lie on the same side of the gear wheel 4 (both motors 10, 11 lie on one side of a virtual plane perpendicular to axes of the worm shafts 6, 7 and passing through the centre point of the gear wheel 4). Considering as an example the perspective shown in FIG. 2, driving both motors 10, 11 clockwise would apply torque in opposite directions to the gear wheel 4, with motor 10 applying a clockwise torque to gear wheel 4 and motor 11 applying an opposing anti-clockwise torque to gear wheel 4.

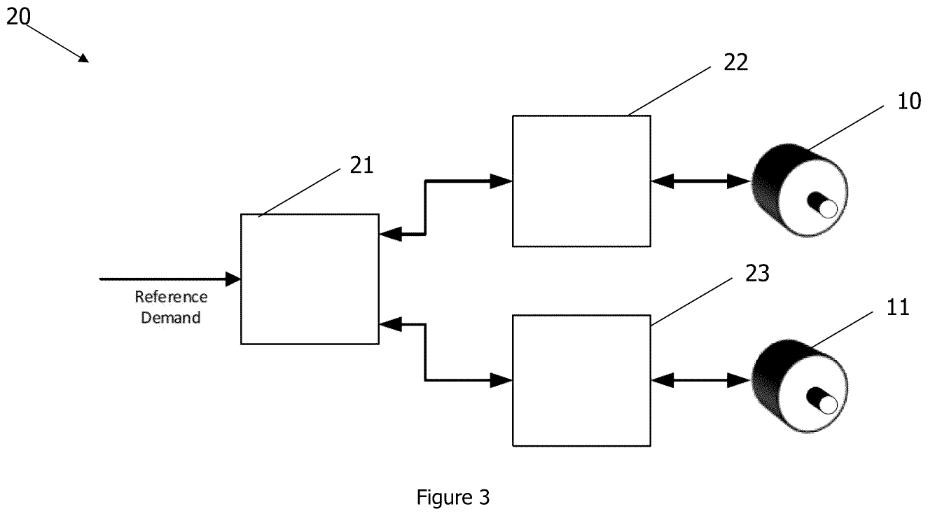

FIG. 2 shows another embodiment of a handwheel actuator assembly 1 according to the first aspect of the invention. This embodiment is substantially similar to the embodiment shown in FIGS. 1 and 2 with the only difference being the positioning of the motors 10, 11. Components and functional units which in terms of function and/or construction are equivalent or identical to those of the preceding embodiment are provided with the same reference signs and are not separately described. The explanations pertaining to FIG. 1 therefore apply in analogous manner to FIG. 3 with the exception of the positioning of the two motors 10, 11.

In FIG. 2 the worm shafts 6, 7 engage diametrically opposed portions of a gear wheel 4 and threads of the worm shafts 6, 7 each have the same sense, i.e., in this example, they are both right-handed screw threads. The motors 10, 11 are configured such that they lie on opposing sides of the gear wheel 4 (motor 10 lies on one side of a virtual plane perpendicular to axes of the worm shafts 6, 7 and passing through the centre point of the gear wheel 4 while motor 11 lies on the other side of this virtual plane).

Application of torque by a driver in a clockwise direction results in rotation of the handwheel 26 and the steering column shaft 3 about the dashed line 5. This rotation is detected by a rotation sensor (not shown). The first motor 10 is then controlled by the ECU 20 to apply torque in the opposite direction. In a first operational mode, the second motor 11 is actuated by the ECU 20 to apply an offset torque 32 in the opposite direction to the torque 30 of the first motor 10 to reduce gear rattling. Alternately, in a second operational mode, the second motor 11 is actuated by the ECU 20 to apply a torque 34 in the same direction to the torque 30 of the first motor 10 to increase the feedback torque to the steering column shaft 3.

The net result of the torques by the first and second motors 10, 11 results in an application of a feedback torque to the steering column shaft 3 and handwheel 26, to provide a sensation of road feel to the driver. In this example, the application of a feedback torque is in the opposite direction to that applied to the handwheel 26 by the driver. In this way, the “rattle” produced between the worm shafts 6, 7 and the gear wheel 4 can be eliminated or significantly reduced.

FIG. 3 reveals part of an HWA assembly 80 showing a general arrangement of an electronic control unit (ECU) 20 which controls each of the two motors 10, 11. The ECU 20 may include a hand wheel actuator (HWA) control system 21 as well as a first and second motor controller 22, 23 which control the first and second motors 10, 11 respectively. A reference demand signal is input to the HWA control system 21 which allocates torque demands to each of the first and second motors 10, 11. These motor torque demands are converted to motor current demands and transmitted to the first and second motor controllers 22, 23. Each motor 10, 11 provides operating feedback to their respective motor controller 22, 23. The HWA control system 21 is configured to calculate the magnitude of mechanical friction using the motor torque demands. In another embodiment, the HWA control system 21 may be implemented by a separate ECU to the first and second motor controller 22, 23.

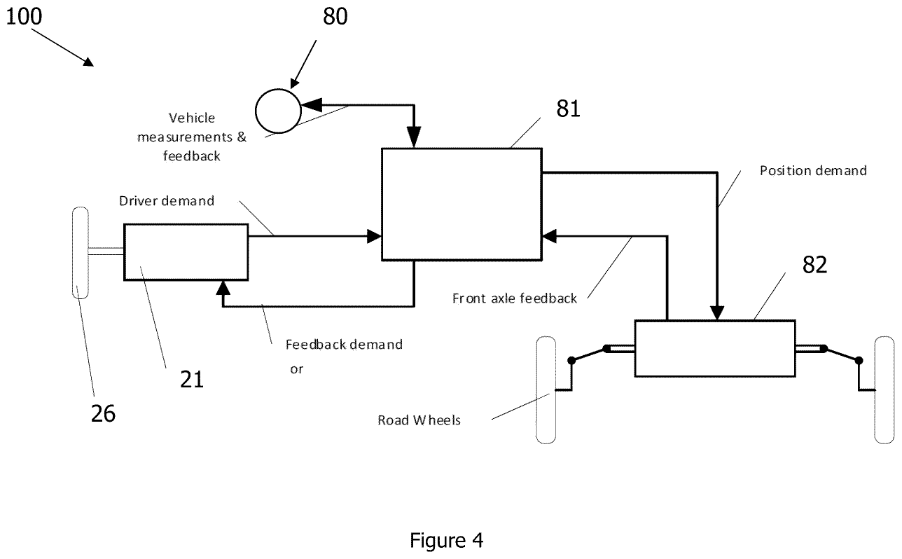

FIG. 4 shows an overall layout of a Steer-by-Wire system 100 for a vehicle including the handwheel actuator (HWA) assembly 80 according to a first aspect of the invention. The HWA assembly 80 supports the driver's handwheel 26 and measures the driver demand which is usually the steering angle. A steering controller 81 converts the driver demand into a position demand that is sent to a front axle actuator (FAA) 82. The FAA 82 controls the steering angle of the roadwheels to achieve the position demand. The FAA 82 can feedback operating states and measurements to the steering controller 81.

The steering controller 81 combines the FAA 82 feedback with other information measured in the vehicle, such as lateral acceleration, to determine a target feedback torque that should be sensed by a driver of the vehicle. This feedback demand is then sent to the HWA control system 21 and is provided by controlling the first and second motors 10, 11 with the first and second motor controllers 22, 23 respectively.

FIG. 4 shows the steering controller 81 as physically separate to both the HWA controller 21 and the FAA 82. Alternately, different architectures, where one or more of these components are physically interconnected, may be used within the scope of this disclosure. For example, the functions of the steering controller 81 may be physically implemented in the HWA controller 21, the FAA 82, or another control unit in the vehicle, or some combination of all 3. Alternatively, control functions ascribed to the HWA controller 21 and FAA 82 may be partially or totally implemented in the steering controller 81.

In the event that there is a fault in the motor windings that prevents any current flowing through the motor, or disconnection of motor from the control electronics, or in the motor drive stage or in the control system, including a loss of electrical power to the handwheel assembly, it becomes impossible to control the rotation of the handwheel by the driver in order to provide feedback. The motors of the handwheel actuator assembly of FIG. 1 are configured in order to ensure that there is some damping of the rotation of the wheel in this condition. This is beneficial as it will feel more natural to the driver and will also help them not make steering inputs at too high a rate by damping their actions.

In a conventional prior art Handwheel actuator assembly the motor is fabricated using a high-performance electrical steel for the stator as it is generally desirable to reduce the level of drag torque and the resulting energy losses. Further reductions are attained by the use of a laminated stator in which electrical steel plates are held apart by interleaved layers of insulating material.

In the embodiment of FIG. 1 and the embodiment of FIG. 2 the two motors are the same and each is configured to provide a substantial level of drag torque when a driver rotates the motor in an unpowered condition by rotating the handwheel. This ensures the handwheel does not spin freely in the event of a fault that removes power from the motor or where the motor has an internal fault that means the current in the windings does not generate any motoring torque in the motor. An added benefit is that more energy is consumed within the motor compared with a low drag torque motor and so there is less for the electronics to do to provide a controlled resistance, heat being dissipated within the motor rather than from the electronics.

The skilled person will understand that the invention can be implemented with only one of the motors providing a substantial drag torque and the other a conventional motor used in prior art handwheel actuators with a low drag torque.

By drag torque we mean the torque arises due to energy conversion within the stator of the motor as it is rotating. Mechanical energy from the driver causes the rotor to rotate. As it rotates the rotor and stator interact magnetically generating a changing flux within the stator. This will give rise to both eddy currents and hysteresis losses and electrical energy is converted to heat as these currents pass through the resistive material forming the stator. Thus, mechanical energy is converted heat and a drag torque results.

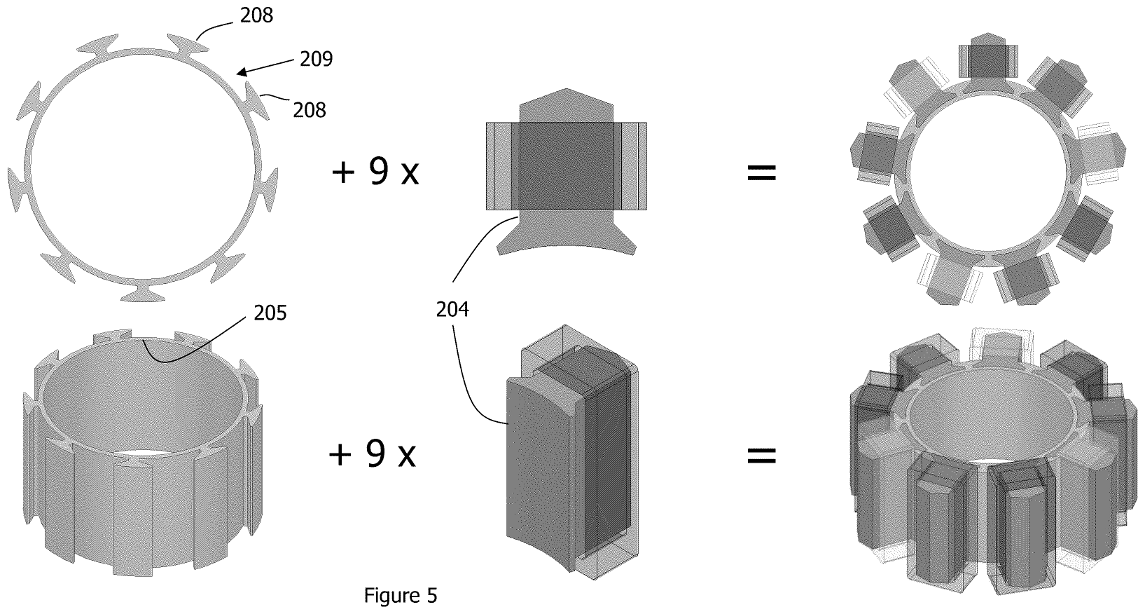

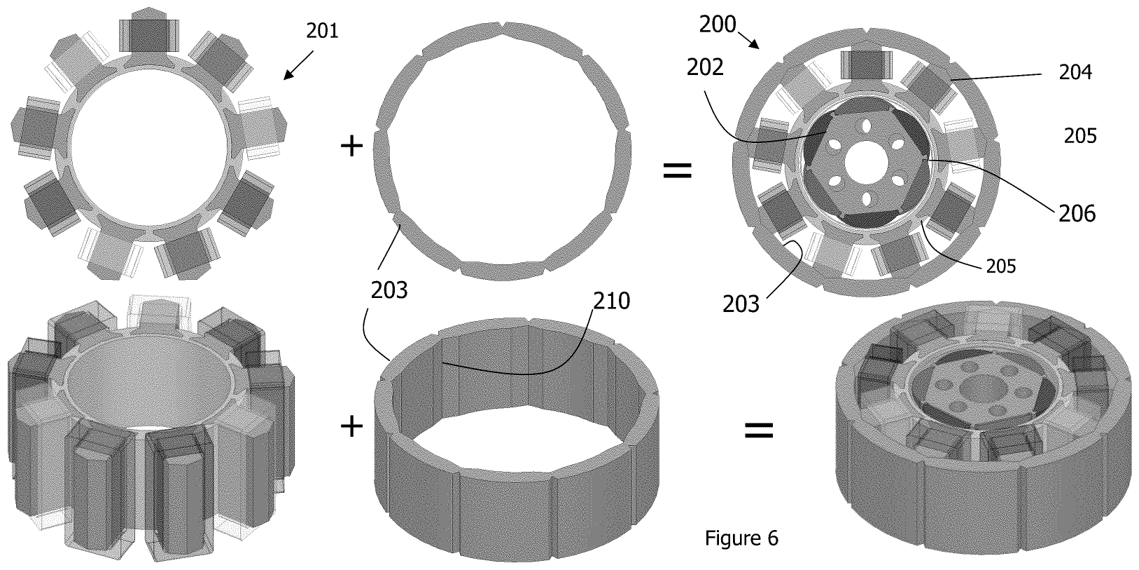

A first construction of a motor 200 which can be used as one or both of the motors 1,11 of FIG. 1 and FIG. 2 is shown in FIGS. 5 and 6 of the drawings. These figures also show the sequence of assembly steps that may be used to assemble the motor.

The motor 200 comprises a rotor 202 and a stator 201. The stator 201 comprises three types of mechanical components, an outer annular yoke 203, a set of 9 teeth 204 and an inner sleeve 205. Coils of conductive wire are also provided which surround the teeth to form an electrical circuit.

The outer yoke body 203 comprises a tube having a substantial circular inner and outer diameter that forms support for the motor teeth at their outermost ends.

The teeth 204 are each identical and comprise a rectangular stack of electrical steel plates laminated together. Each tooth has a stem and at one end has a part which widens to form arcuate tips. These tips and the rotor 202 together form a cylindrical airgap 206.

The inner sleeve 205 is also a continuous tube and has a smooth inner wall that faces the motor rotor across an airgap. As best seen in FIG. 5 the outer wall of the sleeve 205 is provided with a set of slots 209 that extend axially along the sleeve. In this example the slots 209 are defined between a pair of axial ribs 208 that stick out from the outer surface of the sleeve. They could equally be considered to be grooves formed into the outersurface, either interpretation is valid. The side walls of each slot 209 are undercut and the cross section of the slot 209 matches that of the enlarged tip of a tooth 204. When installed as shown to the right hand side in FIG. 5 each slot 209 receives and locates one tooth 204 held by the tip.

The method of assembly of the motor may be as follows:

In a first step, the coils windings are applied to each tooth 204. Then the teeth 204 are fixed to the inner sleeve 205 by sliding the tooth tips into the undercut slots.

Windings of electrical wire are wrapped around the teeth between the outer yoke body 203 and the teeth tips, and these are connected together to form a set of motor phases, for example into three separate phases. Each phase can then be supplied with a current from a motor drive circuit, the modulation of the currents controlling the movement of the motor. Once this has been completed there is a star shaped rotor sub assembly formed as shown in FIG. 5.

In a next step the entire star shaped sub assembly shown on the right hand side of FIG. 5 may be slid into position within the outer yoke 203 as shown in FIG. 6. The ends of the teeth 204 closest to the outer yoke 203 engage with small locating grooves 210 on the inner surface of the outer yoke. The rotor is then placed inside the stator. This is shown in FIG. 6.

When assembled each tooth 204 extends axially down the stator from an upper end to a lower end. The rotor 202 fits within the void defined by the tips of these teeth 203 and has an axis that is common with the axis of the stator yoke. The rotor carries a set of permanent magnets 206.

The stator teeth 204 and rotor 202 define an airgap. In this example the airgap is around 1.2 mm. An inner yoke sleeve 207 of electrically conductive material is located in this air gap that has a length of around 0.4 mm. This has an outer surface that abuts the tips of the teeth and as such takes up a third of the airgap leaving a true airgap remaining of 0.8 mm.

The inner sleeve 205 in this example is a copper tube having perfectly cylindrical inner and outer bores. In a modification, the sleeve may be provided with an assortment of grooves or ribs on either the inner bore or outer bore or both which extend axially along the sleeve. Where outer ribs are provided these may extend into the circumferential spaces between adjacent teeth 204.

FIG. 8 illustrates how Eddy currents are formed in the sleeve due to it having a low electrical resistance and relatively large thickness compared to the length of the airgap. These Eddy currents provide resistance to rotation of the rotor, helping damp the motor movement in the event of a loss of power. This effect occurs because the sleeve will be stationary as the rotor rotates and will therefore be subjected to flux reversals as north and south magnet poles pass radially “underneath” it even when the machine is unpowered. Due to said flux reversals, if this tube is made of conductive material, eddy currents and therefore heat loss will be generated. This will be felt as damping torque to the force rotating the rotor shaft. With carefully chosen (generally high) conductivity, thickness and other geometry features, the machine can be designed to match specific levels of damping torque.

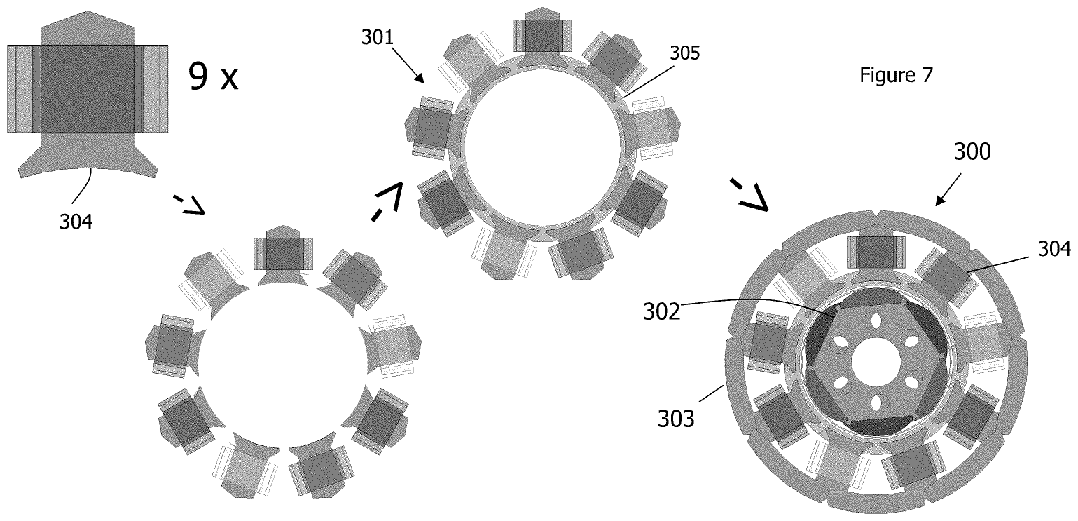

A second exemplary motor 300 within the scope of the present invention is shown in FIG. 7. This is similar to the motor of FIGS. 5 and 6 apart from the inner sleeve 305 being provided in the form of an overmolding in which the tips of separate teeth 304 are embedded to secure them in place. Where like parts are provided they have the same reference numerals as used for the first embodiment but increased by one hundred, and the description of each component in the first embodiment applies equally to this second embodiment so will not be repeated here.

To construct the motor 300 of FIG. 7 a set of teeth are provided. The windings may be applied to the teeth whilst they are separate as shown on may be applied later in the process. The teeth are then arranged in a mold (not shown) in the desired relative orientations. This is shown in the central part of FIG. 7. An epoxy or other moldable material is then poured into the mold or otherwise poured onto the teeth. This takes the shape of an inner sleeve 305 and is allowed to cool where it is a thermoset material or to set in the case of a chemically cured material. Once set the inner sleeve securely locates the teeth in close fitting pockets that define locating features. The star shaped stator 301 formed in this way is the inserted into the outer annular stator yoke in the same way as the first embodiment.

Whilst the motors are especially suited for handwheel actuator application due to the simple assembly and high braking torque the motors can be constructed using an inner sleeve that is an insulating material such as an epoxy. This would allow it to be used in an application where a low braking torque is desirable but also where the benefits of the easy access to the teeth and ease of winding are desirable.

One example of a system in which such a low drag motor is desirable include Fuel cell compressors where the inner sleeve can be made of electrically insulating material to eliminate speed dependent losses. With an insulating inner sleeve part the star stator assembly should have virtually no extra losses compared to a regular stator, while also allowing external, easier access to form the winding in an optimal layout. High-speed machines exhibit significant frequency (speed) dependent additional losses in the winding called “AC winding losses” over the typical ohmic loss i.e. “DC winding losses”. AC winding losses can be mitigated by number of parallel conductors per motor turn (“strands in hand”) and laying said parallel conductors belonging to the same turn as “horizontally” or tangential to the stator diameter in the slot as possible.

The extra access can potentially provide enough flexibility to form the coils in this optimal way or even using pre-wound coils that can then be placed in the necessary slots rather than winding in-situ.

1. An electric motor comprising a stator and a rotor, the stator carrying a plurality of phase windings and the rotor carrying a plurality of magnet poles and being connected to a shaft; and
in which the stator comprises an outer annular yoke, a plurality of discrete teeth that are separate from the annular yoke, each tooth comprising a stem and a tooth tip that is located at the end of the stem closest to the rotor,
and an inner annular sleeve that is located in what is otherwise an airgap between the inwardly facing tips of the stator teeth and the rotor, and in which the inner sleeve includes location features that positively locate and support the teeth by the tips.

2. A motor according to claim 1 in which the inner sleeve comprises an electrically conductive material.

3. A motor according to claim 2 in which the inner sleeve comprises a metal or metal alloy or metal matrix composite.

4. A motor according to claim 1 in which the inner sleeve comprises insulating material.

5. A motor according to claim 1 in which the material is magnetically permeable.

6. A motor according to claim 1 in which the outer yoke includes a set of locating features on an inner surface that engage with the ends of the teeth furthest from the rotor.

7. A motor according to claim 1 in which the outer surface of the inner sleeve includes a plurality of ribs, each rib extending radially outward into a space between adjacent tips of the stator teeth to locate the individual teeth.

8. A motor according to claim 6 in which side walls of each rib include an undercut which receives part of a tooth head so that the teeth cannot move radially, tangentially or circumferentially-away from the inner sleeve.

9. A motor according to claim 1 in which the inner sleeve includes a set of grooves in the outer circumferential surface, each one locating the tip of a tooth and the side walls of the grooves are undercut to positively restrain the tooth.

10. A motor according to claim 1 in which the inner sleeve comprises an overmolding in which at least part of the tip of each tooth is embedded within the overmolded inner sleeve, the-void that the teeth occupy defining the location feature for the tooth.

11. A motor according to claim 1 in which each tooth comprises a generally rectangular block with an enlarged tip extending along one edge that engage the inner sleeve.

12. A motor according to claim 1 in which the sleeve includes a plurality of cuts out that extend from the inner circumferential wall of the sleeve to the outer circumferential wall whereby strips of material are defined between the cut outs that provide the axially conductive paths.

13. A method of assembling a motor having the features of claim 1 comprising:
providing an inner sleeve of electrically conductive material and a set of individual stator teeth,
Forming a sub assembly by fixing the individual teeth to the inner sleeve using the locating features to form a star shaped subassembly and winding electrical wire around the teeth to form the coils; and
Inserting the sub assembly axially into the outer annular yoke.

14. A method according to claim 13 in which the sub assembly is a press fit into the outer annular yoke.

15. A method according to claim 13 comprising applying adhesive to one or more surfaces during assembly such that when the assembly is completed the cured adhesive secures the teeth to the outer yoke and optionally to the inner sleeve

16. A method of assembling a motor having the features of claim 1 comprising:
placing a set of individual stator teeth into a mold or other retaining device,
Forming a sub assembly by overmolding an inner sleeve that encapsulates at least a part of a tip of each tooth to form a star shaped subassembly and winding electrical wire around the teeth to form the coils; and
Inserting the sub assembly axially into the outer annular yoke.

17. A handwheel actuator assembly of a steer by wire vehicle comprising:
a housing;
a shaft rotatably mounted with respect to the housing;
one or more motors each having a stator and a rotor, the stator carrying a plurality of phase windings and the rotor carrying a plurality of magnet poles and being connected to the shaft;
a control circuit adapted to control the current flowing into or out of the or each motor to cause a net torque to be applied to the shaft during normal operation, and
in which at least one of the motors comprises a motor in accordance with claim 1 and in which the inner sleeve comprises an electrically conductive material.
